(19) United States
(12) Patent Application Publication
(10) Pub. No.: US 2006/0043636 A1
(43) Pub. Date: Mar. 2, 2006

(54) Method for preparing brassiere cup

(76) Inventor: Pan-Ting Hsueh, Kowloon (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 10/924,799

(22) Filed: Aug. 25, 2004

(51) Int. Cl. B29C 43/02; B29C 43/52; B29C 67/20; B29C 71/02

(52) U.S. Cl. 264/236; 264/321

(57) ABSTRACT

An improved method of preparing molded seamless breast pads, cups, fronts and the like for use in brassieres and other garments is described. Polyurethane foam sheet, which still contains free isocyanates in its urethane matrix, is sliced from a freshly made foam bun, and placed between the mold parts. The mold parts are then closed by a hydraulic press. Steam is injected through holes in one mold part, and flows throughout the compressed polyurethane foam. Exhaust steam is emitted from holes in the other mold part. Moisture and heat from the steam then accelerate reactions with the free isocyanates and further cure the polyurethane foam material. The polyurethane foam material is therefore molded into the shape of mold parts cavity.

### FIELD OF THE INVENTION

This invention relates to an improved method of preparing molded seamless breast pads, cups, fronts and the like for use in brassieres and other garments. This method is especially useful in the preparation of a molded seamless brassiere cup from a soft polyurethane foam material that is not yet fully cured and has free isocyanates within the urethane polymer matrix. Such foam is sliced into sheet with a thickness greater than the thicker wall of the finished brassiere cup. The molded seamless brassiere cups have a thicker wall at the outer or apex portion than at the peripheral portion thereof. The sliced polyurethane foam sheet is then pressed between mold parts of a female mold part and a male mold part. Mold parts are closed and pressed by hydraulic press. Steam with pressure of approximately 55 pounds per square inch (psi) is then injected through holes in one mold part and passes through the pressed polyurethane foam. Exhaust stream is emitted from holes in the other mold part. Moisture and heat from the steam then accelerate a reaction with the free isocyanates and further cures the polyurethane foam material. The polyurethane foam material is therefore molded into the exact shape of mold parts cavity. The molded polyurethane foam material can be used as seamless breast pads, cups, fronts and the like in brassieres and other garments.

### BACKGROUND OF THE INVENTION

In the manufacture of brassieres and other garments that include formed breast cups, there is a need for resilient materials that can adapt themselves to the various positions and motions of the wearer, while always retaining their original shape. Further, their shape and resilience should not be affected by laundering and machine washing. Still further, brassiere pad requires sufficient porosity, and breathability to improve the comfort of the wearer.

Brassiere pads molded from fiberfill material of varying thickness have been used for many years. Prior art processes have suffered from thinning at the apex and consequently resulted in poor shape stability after laundering and machine washing. In order to overcome this thinning problem, sewing on an apex portion has been a common practice. The sewing cannot meet current fashion requirement for a seamless brassiere cup.

An improvement for making brassiere pad is described by U.S. Pat. No. 4,025,597, issued on May 24, 1977 to Koshi Sawamoto. This invention involves die molding of a resilient fibrous material intermixed with a thermoplastic resin and heating the die molds to a temperature above the softening temperature of the resin. This process requires homogeneous distribution of the thermoplastic resin within the fibrous material and production of brassiere cups with even softness and resilience using this process is difficult. Another drawback of this invention is the requirement for a precise resin amount. Additional resin results in a stiffer brassiere cup and reduced resilience. A brassiere cup with an insufficient amount of resin binding is affected by laundering and results in poor shape stability.

Another method of fabricating a brassiere cup involves thermal formation of a polyurethane foam material as evidenced by U.S. Pat. No. 4,250,137, issued on Feb. 10, 1981 to Walter Riedler. A sheet of polyurethane foam peeled from a polyurethane slab stock foam block is placed between mold parts of the heated female mold part and the heated male mold part, and then hydraulic pressure is applied to press the foam sheet with the mold parts. According to the description in the invention, the temperature of the mold parts is heated to 350-450° F. The pressure applied to said polyurethane foam material is approximately 60 pounds per square inch of mold area and the heat applied to said polyurethane foam material is approximately 400° F., with heat and pressure being applied simultaneously for approximately sixty seconds. Actual process cycle time depends on the thickness of the polyurethane foam sheet. Owing to the low thermal conductivity of the polyurethane foam material, a thicker foam sheet usually requires an even longer process cycle time, in order to allow sufficient cell strut deformation in the center part of the polyurethane foam material. A significant problem in the process is the dissociation of biuret, urea, and urethane bonding in the polyurethane foam material. Prolonged thermal formation cycle time for thicker polyurethane foam material usually results in a severe dissociation problem, especially on the surface of polyurethane foam sheet material. These chemical bonds undergo thermal dissociation in the temperature range of 212-395° F. (Szycher, M., “Szycher's Handbook of Polyurethanes”; CRC Press, Boca Raton, 1999, 2.8.). Toxic hydrogen cyanide fumes can be generated from such chemical bond dissociation as described in Wooley (Wooley, W. D., “Nitrogen Containing Products from the Decomposition of Flexible Polyurethane Foams”; The British Polymer Journal 1972, 4, P.27-43). A further problem with thermal dissociation of polyurethane foam involves the formation of toluenediamine (TDA), diphenylmethane diamine (MDA), and 1-amino-3-aminomethyl-3,5,5-trimethyl cyclohexane (IPDA), depending on the isocyanate used to produce the polyurethane foam materials. Recent evidence indicates that such diamines may represent a potential health hazard. TDI based flexible polyurethane foam dominates the use of molded brassiere cup owing to its ease of production and low material cost. Thermal dissociation while heating polyurethane foam, containing urea and urethane linkages, above 350° F. causes the breakage of urea and urethane bonds to produce free amines, which can be leached from the polyurethane foams. Toluenediamine is a suspected carcinogen, and is toxic (ANSI Z129.1, 1988) when ingested or inhaled (Material Safety Datasheet, “Toluenediamine with water” Air Products, November 2002). Contact with toluenediamine can cause mild skin irritation, which causes safety concerns for use of toluenediamine-containing material in brassiere.

W.R. Grace & Co. invented methods to reduce aromatic amine residuals in polyurethane foam material as evidenced by U.S. Pat. No. 4,211,847, issued on Jul. 8, 1980, and U.S. Pat. No. 4,439,553, issued on Mar. 27, 1984. These two inventions provide methods to lower aromatic amine residue, which is slowly generated from hydrolysis of urea and urethane bonds in polyurethane foams made from TDI or MDI with the addition of a small amount of cyclic or aliphatic isocyanates as amine scavengers. The inventions solve the problem with a much lower amount of TDA or MDA formed in a normal polyurethane foam block, but cannot meet the requirement of scavenging the sudden formation of a larger amount of amine generated in the brassiere cup thermal formation process.

### SUMMARY OF THE INVENTION

This invention relates to an improved method of preparing molded seamless breast pads, cups, fronts and the like for use in brassieres and other garments. This method is especially useful in the preparation of a molded seamless brassiere cup from a soft polyurethane foam material, which has not fully cured and has free isocyanates within urethane polymer matrix.

Full cure of polyurethane foam can be identified by disappearance of isocyanate fingerprint absorption (1432-1205 cm⁻¹) in an infrared spectrum or by titration, which involves adding excess 0.01N dibutylamine in DMF to a foam sample and then titrating excess amine with hydrogen chloride solution A more common industrial practice is to detect the end point of post-curing from disappearance of foam skin stickiness. Fully cured polyurethane foam has no stickiness on its surface skin. The full cure of polyurethane foam can take from 12 hours to 72 hours, and depends on the reactivity of the isocyanates used to produce the polyurethane foam, the amount of excess isocyanates in formulations, the ambient temperature and post-cure conditions. Reference is particularly made to Woods (Woods, G., “The ICI Polyurethanes Book”, John Wiley & Sons, 1987, ISBN 0-471-91426-6, P. 60). The formation of polyurethane foams depends on two basic reactions, which are urea reaction and urethane reaction as described by Oertel (Oertel, G., “Polyurethane Handbook”, ISBN 0-02-948920-2, Hanser Publisher, 1985, P161). Aromatic isocyanates have higher reactivity in urea and urethane formation than aliphatic isocyanates. Therefore, polyurethane foams made from aliphatic isocyanates require a longer post-cure time, and are a preferred polyurethane foam material for the presented invention since they provide sufficient process lead-time. Concerns regarding the hazardous involved with processing under-cure polyurethane foams can be minimized with adequate personal protection equipment and sufficient ventilation in work areas.

In accordance with a preferred embodiment of the present invention, aliphatic isocyanate base polyurethane foam is produced and stored at room temperature for post-curing. After several hours of curing, the polyurethane foam has sufficient strength and can be further processed. The polyurethane foam is then sliced into sheets with thickness about double that of the thickest wall of the finished brassiere cup. A sliced polyurethane foam sheet is then pressed between mold parts of a female mold part and a male mold part. Mold parts are closed and pressed by a hydraulic press. The pressure applied to the polyurethane foam material is approximately 60 pounds per square inch of mold area. Steam with pressure of approximately 55 psi is then injected through holes in the male mold part and passes through the pressed urethane foam. Excess stream is emitted from holes in the female mold part. However, it will be understood that the injection direction of steam will not impact the efficiency of the present invention. Steam can be injected from holes in the female mold part as well. The steam will pass through the cells in the compressed polyurethane foam. Exhaust steam is emitted from holes in the male mold part. The total steam injection procedure takes less than 10 seconds, and, preferably, less than 5 seconds. Moisture and heat from the steam then accelerates reaction with the free isocyanates and further cures the polyurethane foam material. The polyurethane foam material is therefore molded into the shape of the cavity created by the mold parts. The molded polyurethane foam material can be used as seamless breast pads, cups, fronts and the like in brassieres and other garments. The molded seamless brassiere cups have a thicker wall at the outer or apex portion than at the peripheral portion.

The above-discussed problems of the prior art are overcome by the present invention in which molded brassiere cup with sufficient porosity and breathability can be produced. The brassiere cup contains neither toluenediamine nor diphenylmethane diamine residue as generated from the thermal dissociation of polyurethane polymer.

The present invention provides an economic solution to solve the hazardous toluenediamine and diphenylmethane diamine formation seen in the prior arts. The traditional way to produce brassiere cups with thermal deformation of an already-cured polyurethane foam by heating to 350-450° F. for approximately 60 seconds is no longer necessary. The present invention utilizes the moisture and heat from steam to mold fresh-cut polyurethane foam, which still contains free isocyanates within the polyurethane matrix. The whole process takes less cycle time than in previous technology, significantly reduces the heat exposure time of the polyurethane foam, and lowers the maximum process temperature to a degree that no urethane dissociation can take place, thereby eliminating the formation of TDA, MDA, or IPDA.

Another object of the present invention is to eliminate the formation and emission of harmful hydrogen cyanide fumes in the polyurethane foam thermal forming process, and to provide a safe working environment for the brassiere cup molding plant and its employees.

A further objective of the present invention is to develop a method to mold a brassiere cup with reduced production cycle time. With the significant production cycle time reduction, the production capacity of a brassiere cup molding line can be significantly increased.

A yet further object of the present invention is to provide a method to produce a brassiere cup with improved quality consistency. In traditional polyurethane slab stock foam product, final foam hardness and resilience vary within a 10% range, which depends on the post-curing conditions as illustrated by Oertel (Oertel, G., “Polyurethane Handbook”, ISBN 0-02-948920-2, Hanser Publisher, 1985, P169 to P171). A humid and warm post-curing environment can result in an increase of final foam hardness. State-of-the-art foam storage warehouse may reduce such foam hardness variation to within a 2 to 5% range. Such variations cause significant resiliency and hand-feel change in final brassiere cup products made from these polyurethane foam materials. The present invention eliminates the influence of foam post-curing conditions, and therefore results in better brassiere cup consistency.

Still another object of the present invention is to provide a process to mold brassiere cup involving thermally sensitive fabrics or polyurethane foam material made from aliphatic isocyanates. There is a need for brassiere cups to maintain an original color thereof throughout the service period. Any polyurethane foam made from aromatic isocyanates will develop color and gradually turn yellow to dark brown. It is common to introduce an UV stabilizer into such polyurethane foam formulations. The UV stabilizer can only slow down said foam color development for a short period of time, and the foam will still turn dark during the service life thereof. Polyurethane foams made from aliphatic isocyanates are the preferred material for brassiere cup. Urethane made from aliphatic isocyanates has less stable chemical bond strength than that in aromatic urethane polymer and will dissociate at even lower temperatures as described by Szycher (Szycher, M., “Szycher's Handbook of Polyurethanes”; CRC Press, Boca Raton, 1999, 2.8). Therefore the traditional thermal formation process cannot be used to mold polyurethane foam made from aliphatic isocyanates. With the improvement from the present invention, a procedure to mold polyurethane foam made from aliphatic isocyanates has been developed.

The present invention of the method of preparing molded seamless breast pads and the like for use in brassieres from polyurethane foam material comprising the following steps: A) providing a polyurethane foam sheet which is not yet fully cured, and contains free isocyanate in the urethane matrix; B) placing the polyurethane foam sheet between mold parts of a female mold part and a male mold part, the first part and second part of holes being arranged in the mold surfaces, and closing the mold parts with a pressing mechanism; C) injecting steam through the first part of holes in one mold part and introducing steam through the compressed polyurethane foam sheet which accelerates further polymerization of the free isocyanate so as to deform the compressed polyurethane foam into the configuration of the cavity of the mold parts, and emitting exhaust steam from the second part of holes in the other mold part; and D) opening the mold parts with the pressing mechanism, and removing the molded polyurethane foam from the mold parts.

### BRIEF DESCRIPTION OF DRAWINGS

The various objects and advantages of the present invention will be more readily understood from the following detailed description when read in conjunction with the appended drawings:

FIG. 1 is a cross-sectional view of the mold parts in the open position;

FIG. 2 is a cross-sectional view of the mold parts with the female mold part lifted to a position, the male mold thrust into the female mold part and mold parts closed for steam injection;

FIG. 3 is a cross-sectional view of the mold parts with a full lift of the female mold part during the molding cycle;

FIG. 4 is an enlarged cross-sectional view of the mold parts open at the end of a molding cycle, with molded foam lying in the cavity of the female mold part.

### DETAILED DESCRIPTION OF THE INVENTION

While preferred embodiments have been shown and described, it will be understood that various modifications and substitutions may be made thereto without departing from the spirit and scope of the invention. Accordingly, the present invention has been described by way of illustration and is not a limitation. For the ease in explaining the invention, a mold that can mold right and left pair at the same is illustrated.

Foam 10 is a flat polyurethane foam sheet, which has been cut from a slab stock foam bun that still contains free isocyanates. Foam 10 can be cut with any thickness from ¼ to approximately 2 inches, and can be laminated with fabric on one or both sides before the molding process. Foam 10 usually is cut into a shape with dimensions sufficient to cover all the mold area after demolding. A guide pin 22 is located in the center of the female mold part, which guide pin 22 can be thrust into the exhaust steam outlet hole 31 in the male mold part. The exhaust steam outlet hole 31 is in the center of the male mold part, and has a diameter of one-eighth inch. A worker can use it as a guide to position a polyurethane foam sheet into the right position, and penetrate the foam 10 with the guide pin 22 to ensure that the foam 10 will not move while the mold is closing.

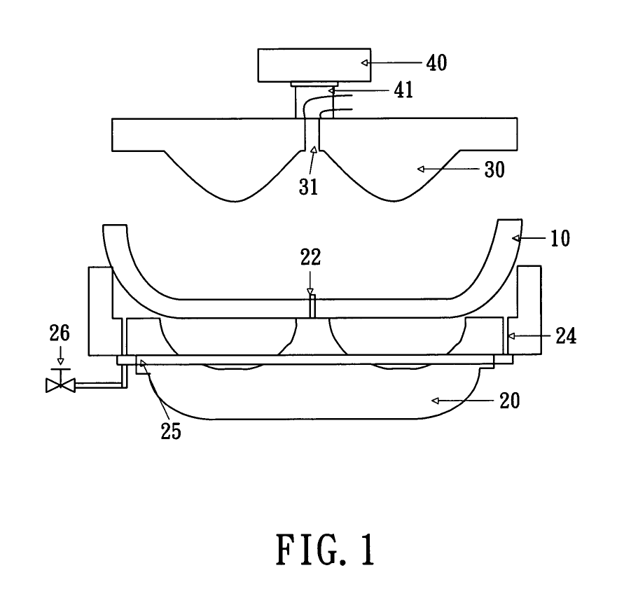

As shown in FIG. 1, foam 10 is affixed to the guide pin 22, and placed on top of the female mold part 20. The female mold part 20 has approximately eight steam inlet holes 24 of one-sixteenth inch diameter in the peripheral portion surrounding each bra pad. All these steam inlet holes 24 are linked to a steam pipe 25, which is built under the female mold 20. The steam pipe 25 has a switch valve 26 controlled by a process sequence control device, which is not shown in the drawings, in order to allow steam injection control. Also shown in FIG. 1 is male mold part 30, which is mounted on a hydraulic piston 41 and can move downwardly to thrust into the female mold part 20. A hydraulic device 40 is mounted on the top to drive the piston with a pressure of approximately 50 to 60 psi on the mold area.

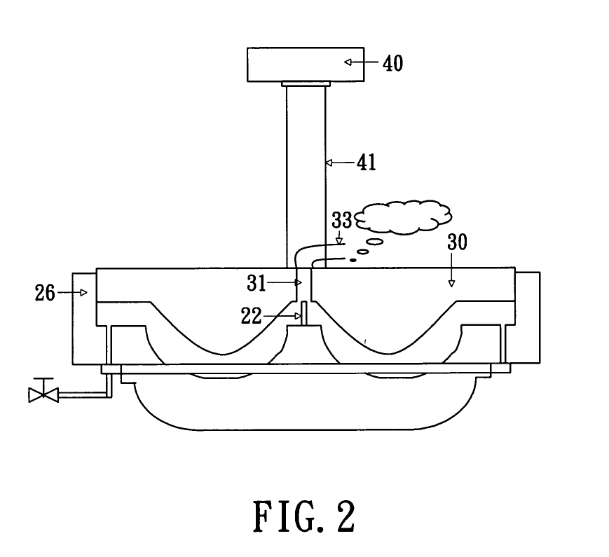

As shown in FIG. 2, when the molding process cycle is started, the hydraulic device 40 presses the piston 41 and the male mold part 30 downward and thrusts the same into the female mold part 20. The movement of the male mold part 30 is guided by the guide-frame 26 built on the edge of the female mold part 20, and closes the mold parts. The guide-pin 22 on the center of female mold part 20 can penetrate into the exhaust steam outlet hole 31 in the male mold part 30, but does not block the exhaust steam outlet hole 31. When the male mold part 30 is lowered to the first position that closes the mold parts, it just slightly deforms the foam 10. The male mold part 30 stops and holds at the position for five to ten seconds for a steam injection and purge through the foam 10. Actual time will depends on isocyanate residual level, and the polymer physical properties, e.g. porosity, of foam 10. When male mold part 30 is lowered to the position, the process sequence control device opens the steam control valve 26 for specified period of time, and then turns valve 26 off. Steam passes through the entirety of foam 10, and heats the same to a temperature of approximately 240° F. Exhaust steam passes through the exhaust steam outlet hole 31 in the male mold part 30, and is emitted through opening 33 into a scrubber system, which is not shown in the drawings.

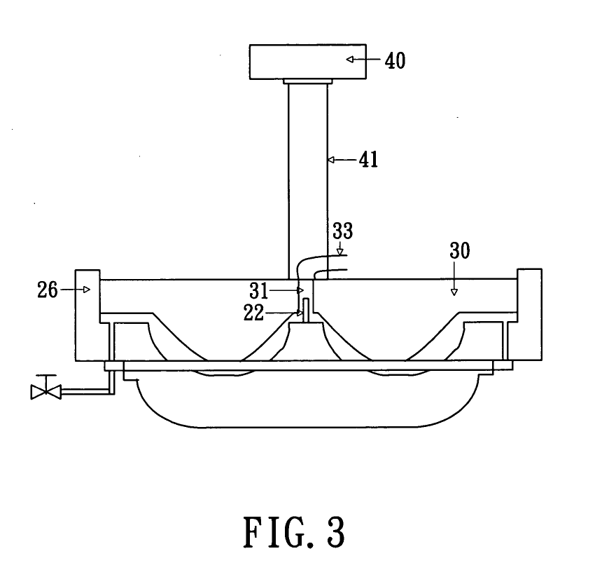

Reference is made to FIG. 3. After the steam purge, the hydraulic piston 41 then further presses the male mold part 30 with a pressure of approximate sixty psi on the foam 10 and the female mold part 20 for about ten seconds to mold the foam 10. The time required in this mold cycle depends on the physical properties of the foam, and the core temperature in the foam polymer.

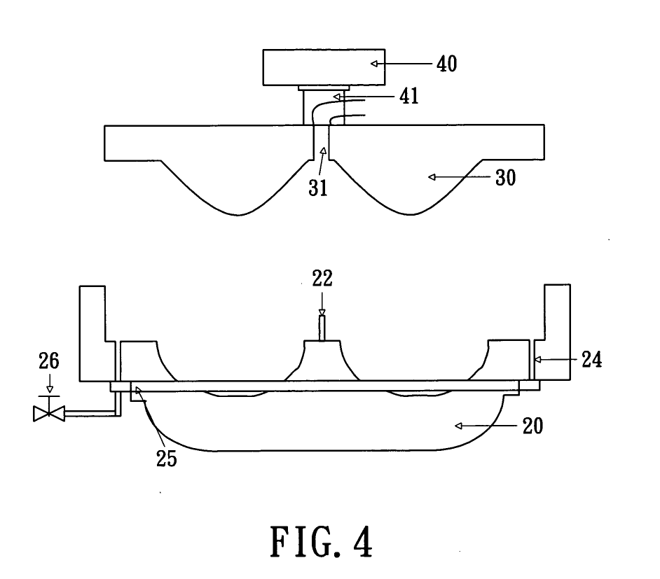

As shown in FIG. 4, the male mold part 30 is withdrawn upward from the female mold part 20 and returned to its original position, as the last step in the whole molding cycle. Foam 10 is then molded into the exact shape of the mold parts cavity, and can be removed from the mold parts. The whole mold cycle takes approximately twenty seconds.

The molded polyurethane foam is then sent to a vacuum chamber, which is not shown in the drawings, for drying. The chamber is connected to a vacuum system, which continuously supplies vacuum of approximately 80 torr. to the chamber. Under ambient temperatures, the whole drying cycle takes about 1 hour. The dried polyurethane foam material can be used as seamless breast pads, cups, fronts and the like for use in brassieres and other garments.

The following examples, while not required to complete the disclosure of the present invention, are present for purposes of illustration

Test Procedures:

1. Free NCO % in Foam:

Excess 0.01N dibutylamine in DMF is added to a 0.5 gram of foam sample and then excess amine is titrated with hydrogen chloride solution. NCO % is illustrated as:
(Equivalent of NCO group in foam sample*42 gram/equivalent)/(total foam sample weight in gram)

Limit of Detection (LOD) is the minimum concentration of a component that can be measured and reported with confidence where the concentration is greater than zero. The LOD for this described method is approximately 0.02%.

2. TDA/MDA/IPDA Concentration in Foam:

A 0.5 gram foam sample is extracted with 3 ml of 1% (v/v) acetic acid aqua solution. The extract is submitted to high performance liquid chromatography (HPLC, Hewlett Packard HP 1050) equipped with a C18 reversed-phase column and UV detector. The concentration is reported in ppm. The concentration of isomer is reported separately. Limit of Detection (LOD) is the minimum concentration of a component that can be measured and reported with confidence where the concentration is greater than zero. The LOD for this described method is about 0.2 mg/kg of foam.

3. Foam Airflow:

Foam porosity is illustrated by an airflow value, which is measured by test method ASTM D3574-95 and reported in cubic feet/min (cfm).

A description of the raw materials used in the examples is as follows:

TABLE 1
Material description

| | |
|---|---|
| Voranol 3137A | is a glycerin initiated |
| | propylene-oxide/ethylene-oxide copolymer with |
| | OH number of 56 from the Dow Chemical |
| | Company |
| Desmophen | is polyester polyol with OH number of 60 from |
| 2200 B | Bayer Company |
| Voranate T-80 | is an 80/20 blend of 2,4/2,6 isomers of toluene |
| | diisocyanate from the Dow Chemical Company |
| Desmodur I | is isophorone diisocyanate (IPDI) from Bayer |
| | Company |

### EXAMPLES 1 to 9

Semi-commercial scale free-rise boxfoams were produced to evaluate reaction speed, in order to determine the concentration of isocyanate residual in foam at specified time. TDI based polyether foam and IPDI based polyester foam with dimension of about 3.5 ft (length)*3.5 ft (width)* 3 ft (height) which has foam density of about 2.2 pcf (pounds per cubic foot) were produced and then stored at 80° F./60% humidity for post-curing. The foam specimen was cut from the center after the specified post-curing period, for free NCO % and airflow tests.

TABLE 2
Semi-commercial scale free-rise foam

| | | | | | | | | | |
|---|---|---|---|---|---|---|---|---|---|
| Foam Number | 1 | 2 | 3 | 4 | 5 | 6 | 7 | 8 | 9 |
| Voranol 3137A | 100 | 100 | 100 | 100 | | | | | |
| Polyester | | | | | 100 | 100 | 100 | 100 | 100 |
| Polyol | | | | | | | | | |
| Water | 2.8 | 2.8 | 2.8 | 2.8 | 2.8 | 2.8 | 2.8 | 2.8 | 2.8 |
| Voranate T-80 | 33.4 | 33.4 | 33.4 | 33.4 | | | | | |
| Desmodur I | | | | | 49.4 | 49.4 | 49.4 | 49.4 | 49.4 |
| Isocyanate | 100 | 100 | 100 | 100 | 104 | 104 | 104 | 104 | 104 |
| Index | | | | | | | | | |
| Free-rise Foam | | | | | | | | | |
| Airflow (cfm) | 4.8 | 4.6 | 4.8 | 4.8 | 2.3 | 2.2 | 2.3 | 2.2 | 2.2 |
| Post-cure | 0.5 | 2 | 4 | 336 | 0.5 | 2 | 4 | 48 | 336 |
| time (hrs) | | | | | | | | | |
| Free NCO | 0.46% | 0.13% | 0.04% | <LOD | 7.60% | 7.14% | 6.52% | 1.12% | <LOD |
| (wt %) | | | | | | | | | |
| TDA in Foam | <LOD | <LOD | <LOD | 2.8 | N.A. | N.A. | N.A. | N.A. | N.A. |
| (ppm) | | | | | | | | | |
| IPDA in | N.A. | N.A. | N.A. | N.A. | <LOD | <LOD | <LOD | <LOD | <LOD |
| Foam (ppm) | | | | | | | | | |
| Density | 2.2 | 2.2 | 2.2 | 2.2 | 2.4 | 2.4 | 2.3 | 2.4 | 2.5 |
| (pcf) | | | | | | | | | |

TDA concentration is reported as sum of 2,4-TDA and 2,6-TDA
<LOD: below detection limit
N.A.: not tested

### EXAMPLES 10 to 18

Foam specimens of 10 in. (length)×10 in. (width)×1.5 in. (depth), which were cut from foam buns produced in examples 1 to 9, were molded according to present invention immediately after cutting. A “K” type thermal couple, which was linked to a thermograph, was inserted and buried in the center of the foam, in order to record the maximum foam temperature during the molding procedure. Mold parts as described in TABLE 3 were used through out the evaluations. Mold parts have built-in electric heaters capable of heating the mold parts to a specified temperature. The mold parts were installed on a hydraulic press device built by Shen-Lin Industries Co. Ltd. in Hong Kong. The device is capable of providing pressure of approximately 60 psi on the mold area. Steam of approximately 56 psi was injected through the holes on the edge of the male mold part for specified time after the first stage of mold closure.

Exhaust steam was emitted from the holes on the female mold part. The mold parts were then closed with a pressure of 60 psi and compressed the foam specimen into the exact shape of the mold parts cavity for a specified time. Molded foam specimen was then removed from the mold parts after opening the mold parts.

TABLE 3
Description of mold parts

| | Female Mold | Male Mold |
|---|---|---|
| | Part | Part |
| Cup Size | “B” Cup Size | |
| Circumference | 17½ in. | 17 in. |
| Altitude | 3 in. | 2½ in. |
| Number of | 6 | 12 |
| Holes | | |

TABLE 4

| | | | | | | | | | |
|---|---|---|---|---|---|---|---|---|---|
| Example | 10 | 11 | 12 | +TA,18/ 13 | 14 | 15 | 16 | 17 | 18 |
| Foam Number | 1 | 2 | 3 | 4 | 5 | 6 | 7 | 8 | 9 |
| Steam | 54 | 58 | 56 | 58 | 53 | 52 | 55 | 52 | 56 |
| Pressure | | | | | | | | | |
| (psi) | | | | | | | | | |
| Steam | 5 | 5 | 5 | 5 | 7 | 7 | 7 | 7 | 7 |
| Injection | | | | | | | | | |
| Time (sec) | | | | | | | | | |
| 2nd Mold | 15 | 15 | 15 | 15 | 15 | 15 | 15 | 15 | 15 |
| Compression | | | | | | | | | |
| (sec) | | | | | | | | | |
| Max. Foam | 260 | 266 | 257 | 264 | 273 | 274 | 276 | 268 | 275 |
| Core Temp. | | | | | | | | | |
| (° F.) | | | | | | | | | |
| Moldability (*) | Î | Î | | X | Î | Î | Î | Î | X |
| TDA in Foam | <LOD | 1.1 | 1.4 | 3.4 | | | | | |
| (ppm) | | | | | | | | | |
| IPDA in | | | | | <LOD | <LOD | <LOD | <LOD | <LOD |
| Foam (ppm) | | | | | | | | | |

<LOD: below detection limit
Î: Molded foam can maintain the exact shape of mold parts cavity
Molded foam can maintain the shape of mold parts cavity, but with moldability failure at the peripheral portion
X: Foam could not be molded
TDA concentration is reported as sum of 2,4-TDA and 2,6-TDA

### REF. EXAMPLES A to I

Foam specimens were molded on a commercial brassiere-cup molding machine (KV-268, built by Shen-Lin Industries Co. Ltd. in Hong Kong). The machine has a built-in horizontal hydraulic press, which can provide approximate 60 psi pressure on the mold area. A pair of “B” size cup aluminum-made mold parts, which had an electric heater built into both mold parts, was attached to the press. The shape of the “B” cup size mold parts has the same dimension as the ones described in TABLE 3. Foam specimens cut from Foam bun sample 1 and 5 were used in EXAMPLE A and E. Foam specimens cut from foam bun samples 4 and 9, which had been cured from 14 days and had no free isocyanate in foam polymer, were used in other examples in this evaluation. A “K” type thermal couple, which was linked to a thermograph, was inserted and buried into the center of foam specimen to measure the maximum foam core temperature during the molding process. Surface temperature of each mold part was set to a specified temperature. A surface temperature probe was used to measure actual temperature of the mold part surfaces. When the surface temperature had reached the desired temperature, a foam specimen of 10 in. (length)×10 in. (width)×1.5 in. (depth) was placed between the mold parts, and then compressed by the heated mold parts with 60 psi hydraulic pressure for a specified period of time. Mold parts were then opened and the molded foam was removes from the mold parts.

TABLE 5

| | | | | | | | | | |
|---|---|---|---|---|---|---|---|---|---|
| Example | A | B | C | D | E | F | G | H | I |
| Foam Number | 1 | 4 | 4 | 4 | 5 | 9 | 9 | 9 | 9 |
| Temp Setting, | 400 | 400 | 450 | 450 | 370 | 400 | 400 | 450 | 450 |
| Male Mold | | | | | | | | | |
| (° F.) | | | | | | | | | |
| Temp Setting, | 400 | 400 | 450 | 450 | 370 | 400 | 400 | 450 | 450 |
| Female Mold | | | | | | | | | |
| (° F.) | | | | | | | | | |
| Surface Temp, | 397 | 395 | 456 | 452 | 371 | 398 | 402 | 446 | 449 |
| Male Mold | | | | | | | | | |
| (° F.) | | | | | | | | | |
| Surface Temp, | 405 | 400 | 452 | 447 | 375 | 404 | 403 | 450 | 455 |
| Female Mold | | | | | | | | | |
| (° F.) | | | | | | | | | |
| Mold Compress | 60 | 90 | 60 | 90 | 60 | 60 | 90 | 60 | 90 |
| Time (sec) | | | | | | | | | |
| Max Foam | 376 | 394 | 423 | 441 | 353 | 371 | 392 | 428 | 443 |
| Core Temp | | | | | | | | | |
| (° F.) | | | | | | | | | |
| Moldability | | Î | | Î | | | | X | X |
| Foam Surface | Good | Good | Good | Good | Good | Good | Good | Scorch | Scorch |
| after Molding | | | | | | | | | |
| 2,4 TDA in | 18.1 | 22.9 | 32.9 | 59 | | | | | |
| Foam (ppm) | | | | | | | | | |
| 2,6 TDA in | 12.1 | 17.2 | 26.7 | 34.8 | | | | | |
| Foam (ppm) | | | | | | | | | |
| Total TDA in | 30.2 | 40.1 | 59.6 | 93.8 | | | | | |
| Foam (ppm) | | | | | | | | | |
| IPDA in | | | | | 42.2 | 59.3 | 74.7 | 94.8 | 124.1 |
| Foam (ppm) | | | | | | | | | |

Î: Molded foam can maintain the exact shape of mold parts cavity
Molded foam can maintain the shape of mold parts cavity, but with moldability failure at the peripheral portion
X: Foam could not be molded

The above described is summarized in the following to illustrate the feature of the invention: the present invention of the method of preparing molded seamless breast pads and the like for use in brassieres from polyurethane foam material comprises steps of: A) providing a polyurethane foam sheet which has not yet been fully cured, and contains free isocyanate in the urethane matrix; B) placing the polyurethane foam sheet between mold parts of a female mold part and a male mold part, the first part and second part of holes being arranged in the mold surfaces, and closing the mold parts with a pressing mechanism; C) injecting steam through the first part of holes in one mold part and introducing the steam through the compressed polyurethane foam sheet which accelerates further polymerization of the free isocyanate so as to deform the compressed polyurethane foam into the configuration of the cavity of the mold parts, and emitting exhaust steam from the second part of holes in the other mold part; and D) opening the mold parts by pressing mechanism, and removing the molded polyurethane foam from the mold parts. The first part of holes can be recognized as steam inlet holes 24 and the second part of the holes can be recognized as the steam outlet holes 31.

The various applied conditions of the present invention are also described as follows. Firstly, the polyurethane foam sheet can suitably contain free isocyanate group with a weight ratio of 0.02 to 10.0% or with a weight ratio of 0.04 to 8.5%. Secondarily, the polyurethane foam sheet has a suitable thickness of about to 2 inches. Thirdly, the polyurethane foam sheet can have fabric laminated on the surface. In addition, the hydraulic pressure to close the mold parts and to compress said polyurethane foam sheet is suitably from 30 to 90 pounds per square inch of mold area. Since the steam pressure is necessary to fit the material property of foam 10, the injected steam can have pressure from 20 to 80 psi. Further, the steam is injected into the mold parts that can contain compressed foam from 3 to 10 seconds. For the convenience of the equipment application, the pressing mechanism can be of the hydraulic type. Also for the ease of application, the polyurethane foam sheet can be obtained by slicing a polyurethane foam bun. For the convenience of manufacturing the final part, the action of closing molds of the step B can have the feature of maintaining a clearance of 1-10 mm between the polyurethane foam sheet and the male mold or female mold to let the steam flow smoothly.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A method of preparing molded seamless breast pads, cups and fronts for use in brassieres and other garments from polyurethane foam material, comprising steps of:
a) providing a polyurethane foam sheet, wherein the polyurethane foam sheet is not yet fully cured, and contains free isocyanate in the urethane matrix;
b) placing the polyurethane foam sheet between a female mold part and a male mold part, wherein a first set and a second set of holes are located in mold surfaces, and closing the mold parts with a pressing mechanism to form a compressed polyurethane foam sheet;
c) injecting steam through the first set of holes in one mold part and introducing the steam through the compressed polyurethane foam sheet to accelerate further polymerization of the free isocyanate and deform the compressed polyurethane foam into a configuration of a cavity between the mold parts, and emitting exhaust steam from the second set of holes in another mold part; and
d) opening the mold parts with the pressing mechanism, and removing a molded polyurethane foam from the mold parts.

2. The method of claim 1, wherein the polyurethane foam sheet contains free isocyanate groups with a weight ratio of about 0.02 to 10.0%.

3. The method of claim 2, wherein the polyurethane foam sheet contains free isocyanate groups with a weight ratio of about 0.04 to 8.5%.

4. The method of claim 1, wherein the polyurethane foam sheet has a thickness of about to 2 inches.

5. The method of claim 4, wherein the polyurethane foam sheet has fabric laminated on a surface thereof.

6. The method of claim 1, wherein hydraulic pressure to close the mold parts and to compress said polyurethane foam sheet is about 30 to 90 pounds per square inch of mold area.

7. The method of claim 1, wherein the steam has a pressure of about 20 to 80 psi.

8. The method of claim 1, wherein the steam is injected into the mold parts containing the compressed polyurethane foam sheet for about 3 to 10 seconds.

9. The method of claim 1, wherein the pressing mechanism is a hydraulic pressing mechanism.

10. The method of claim 1, wherein the polyurethane foam sheet is sliced from a polyurethane foam bun.

11. The method of claim 1, wherein closing of the molds in step b) maintains a clearance of about 1-10 mm between the polyurethane foam sheet and the male mold or female mold.
